(19) United States
(12) Patent Application Publication
(10) Pub. No.: US 2015/0277498 A1
(43) Pub. Date: Oct. 1, 2015

(54) FLEXIBLE ELECTRONIC DEVICE

(71) Applicant: TIANJIN FUNAYUANCHUANG TECHNOLOGY CO.,LTD., Tianjin (CN)

(72) Inventors: HO-CHIEN WU, New Taipei (TW); MING-CHUN CHIU, New Taipei (TW); XIAO YAN, Tianjin (CN)

(21) Appl. No.: 14/674,064

(22) Filed: Mar. 31, 2015

(30) Foreign Application Priority Data
Apr. 1, 2014 (CN) 201410127823.0

(51) Int. Cl. G06F 1/16; G06F 3/041

(52) U.S. Cl. CPC G06F 1/1652; G06F 3/0412; G06F 1/1643; G06F 1/1635

(57) ABSTRACT

A flexible electronic device comprises a shell, a touch module, a battery module, and an information processing and storage module. The touch module is located in the shell to sense input signals and convert the input signals into electronic signals. The battery module is used to supply power to the touch module, and all of the shell, the touch module, and the battery module are flexible. The information processing and storage module is capable of converting the electronic signals into control commands. The communication module is electrically connected to the information processing and storage module.

### CROSS-REFERENCE TO RELATED APPLICATIONS

This application claims all benefits accruing under 35 U.S.C. §119 from China Patent Application No. 201410127823.0, filed on Apr. 1, 2014, in the China Intellectual Property Office, the disclosure of which is incorporated herein by reference.

### BACKGROUND

1. Technical Field

The present disclosure relates to flexible electronic device, particularly to a flexible electronic device capable of sensing touch points.

2. Description of Related Art

With the development of electronic technologies, various kinds of display apparatuses with touch screen have been developed. In particular, display apparatuses such as television (TVs), personal computers (PCs), laptops, tablet PCs, mobile phones, and MP3 players are widely used.

However, the touch screen is usually fixed on the display apparatuses in a fixed form such as tablet PCs or mobile phones and cannot be separated from the display apparatuses. Furthermore, a power source is further required to supply power to the touch screen.

What is needed, therefore, is to provide a flexible electronic device for solving the problem discussed above.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 shows a schematic view of one embodiment of a flexible electronic device.

FIG. 2 shows a schematic view of one embodiment of a flexible touch module in the flexible electronic device of FIG. 1.

FIG. 3 shows a scanning electron microscope (SEM) image of a carbon nanotube film.

FIG. 4 shows a schematic view of one embodiment of a flexible battery module in the flexible electronic device of FIG. 1.

FIG. 5 shows a schematic view of one embodiment of a positive electrode and a negative electrode in the flexible battery module.

FIG. 6 shows a schematic view of one embodiment of the flexible touch module and the flexible battery module connected via a wireless charging manner.

FIG. 7 shows a schematic view of one embodiment of a flexible shell in the flexible electronic device.

FIG. 8 shows a schematic view of another embodiment of a flexible electronic device.

FIG. 9 shows a schematic view of another embodiment of a flexible electronic device.

FIG. 10 shows a schematic view of another embodiment of a flexible electronic device.

FIG. 11 shows a schematic view of another embodiment of a flexible electronic device.

FIG. 12 shows a schematic view of another embodiment of a flexible electronic device.

FIG. 13 shows a schematic view of one embodiment of controlling a TV set via the flexible electronic device.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

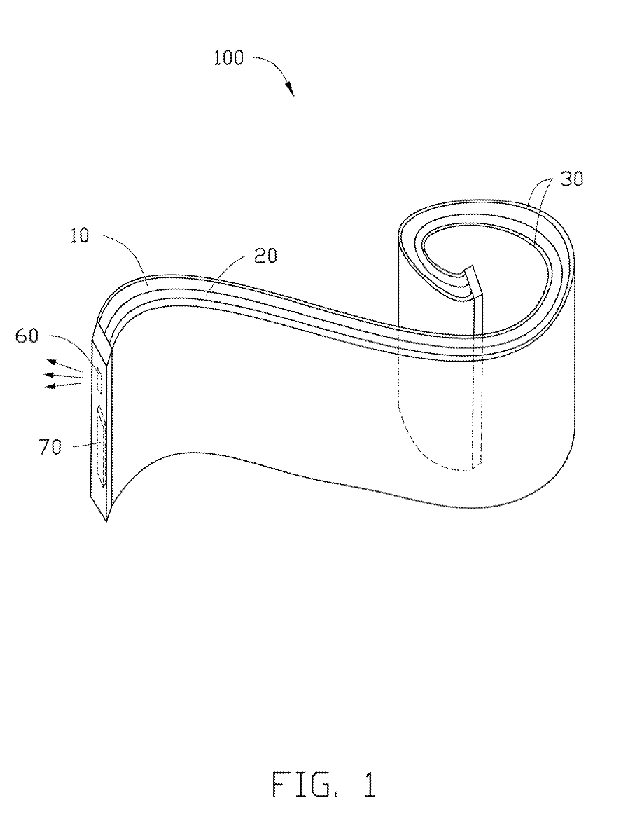

Referring to FIG. 1, one embodiment of a flexible electronic device 100 comprises a touch module 10 and a battery module 20 stacked together. Both the touch module 10 and the battery module 20 are flexible.

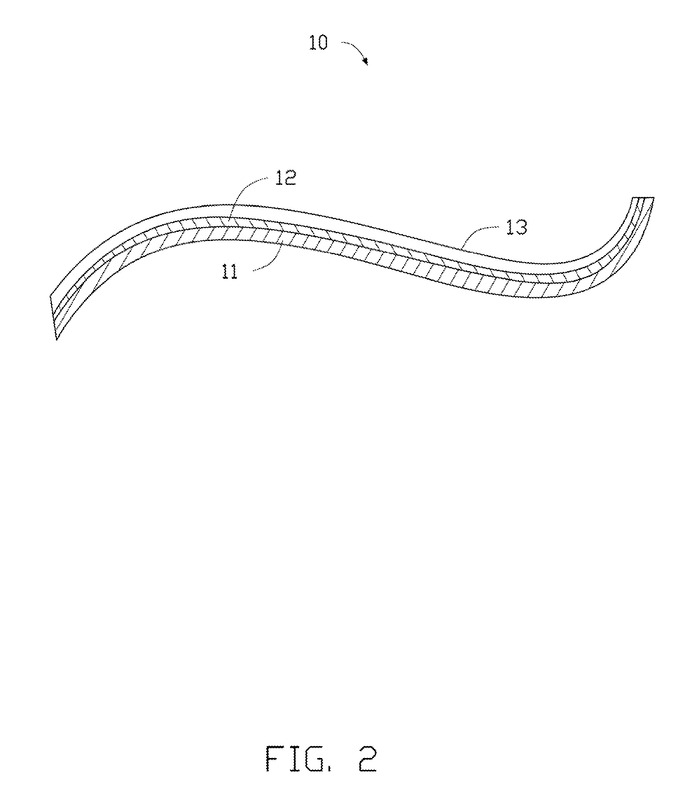

Further referring to FIG. 2, the touch module 10 is a flexible structure and capable of sensing input signal such as touching signal and transferring the signal into electric signals. A bending angle of the flexible touch module can be equal to or greater than 180°. The flexible touch module 10 is capable of being crimped and folded without damage. Furthermore, the touch module 10 can be deformed according different surfaces of different objects, thus the touch module 10 can be attached on the surface of the object.

The touch module 10 comprises a flexible substrate 11 and a flexible first conductive layer 12 located on the flexible substrate 11. The substrate 11 is used to support and protect the first conductive layer 12. The substrate 11 can comprise of polyethylene terephthalate, cycloolefincopolymer, polycarbonate polystyrene, polyethylene, polymethyl methacrylate, polyimide, or any combination thereof. The substrate 11 can be in a shape of sheet. A thickness of the substrate 11 can range from about 50 micrometers to about 800 micrometers. Therefore, the substrate 11 has certain strength to endure the deformation of the touch module 10. Furthermore, the substrate 11 can be transparent. In one embodiment, the material of the substrate 11 can be polyethylene terephthalate, and the thickness is about 200 micrometers.

The substrate 11 comprises a first surface and a second surface that are opposite to each other. The first conductive layer 12 can be located on the first surface. The first conductive layer 12 is used to sense signal. The first conductive layer 12 is flexible and can be bent, folded, or crimped. The first conductive layer 12 can be directly attached to the substrate 11. The first conductive layer 12 can be an anisotropic impedance layer. In the present disclosure, the anisotropic impedance means a structure having a relatively low impedance direction D (e.g., a first direction) and a relatively high impedance direction H (e.g., a second direction) on the same surface (e.g., the surface of the first conductive layer 12). The electrical conductivity of the anisotropic impedance layer on the relatively high impedance direction H is smaller than the electrical conductivities of the anisotropic impedance layer on other directions. The electrical conductivity of the anisotropic impedance layer on the relatively low impedance direction D is larger than the electrical conductivities of the anisotropic impedance layer in other directions. The relatively high impedance direction H is different from the relatively low impedance direction D. In one embodiment, the relatively high impedance direction H is perpendicular to the relatively low impedance direction D. The relatively high impedance direction H and the relatively low impedance direction D of the anisotropic impedance layer can be achieved by having a plurality of conductive belts having a low conductivity aligned along the relatively high impedance direction H and a plurality of conductive belts having a high conductivity aligned along the relatively low impedance direction D, and the plurality of conductive belts having the low conductivity and the plurality of conductive belts having the low conductivity are electrically connected with each other. In another embodiment, the relatively high impedance direction H and the relatively low impedance direction D of the anisotropic impedance layer can be achieved by having a carbon nanotube film.

The carbon nanotube film comprises a plurality of carbon nanotubes substantially arranged along the first direction, so that the first carbon nanotube layer has a larger electrical conductivity at the first direction than at other directions. The electrical conductivity along the first direction is 70-500 times higher than the electrical conductivity along the second direction. Furthermore, the plurality of carbon nanotubes are parallel with the first surface of the substrate 11. In one embodiment, the carbon nanotube film can consists of carbon nanotubes, and the transparent of the touch module 10 can be improved.

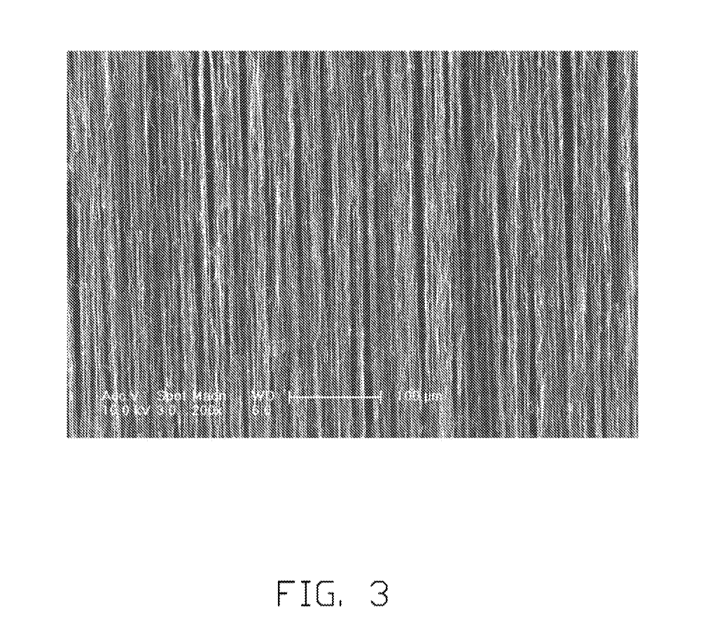

In one embodiment, the carbon nanotube film can be a carbon nanotube drawn film. Referring to FIG. 3, the carbon nanotube drawn film includes a plurality of carbon nanotubes that can be arranged substantially parallel to a surface of the carbon nanotube drawn film. A large number of the carbon nanotubes in the carbon nanotube drawn film can be oriented along a preferred orientation, meaning that a large number of the carbon nanotubes in the carbon nanotube drawn film are arranged substantially along the same direction. An end of one carbon nanotube is joined to another end of an adjacent carbon nanotube arranged substantially along the same direction, by Van der Waals attractive force. A small number of the carbon nanotubes may be randomly arranged in the carbon nanotube drawn film, and has a small if not negligible effect on the larger number of the carbon nanotubes in the carbon nanotube drawn film arranged substantially along the same direction. The carbon nanotube drawn film is capable of forming a free-standing structure. The term “free-standing structure” can be defined as a structure that does not have to be supported by a substrate. For example, a free standing structure can sustain the weight of itself when it is hoisted by a portion thereof without any significant damage to its structural integrity. So, if the carbon nanotube drawn film is placed between two separate supporters, a portion of the carbon nanotube drawn film, not in contact with the two supporters, would be suspended between the two supporters and yet maintain film structural integrity. The free-standing structure of the carbon nanotube drawn film is realized by the successive carbon nanotubes joined end to end by Van der Waals attractive force.

It can be appreciated that some variation can occur in the orientation of the carbon nanotubes in the carbon nanotube drawn film as can be seen in FIG. 3. Microscopically, the carbon nanotubes oriented substantially along the same direction may not be perfectly aligned in a straight line, and some curved portions may exist. It can be understood that some carbon nanotubes located substantially side by side and oriented along the same direction being contact with each other cannot be excluded.

More specifically, the carbon nanotube drawn film includes a plurality of successively oriented carbon nanotube segments joined end-to-end by Van der Waals attractive force therebetween. Each carbon nanotube segment includes a plurality of carbon nanotubes substantially parallel to each other, and joined by Van der Waals attractive force therebetween. The carbon nanotube segments can vary in width, thickness, uniformity, and shape. The carbon nanotubes in the carbon nanotube drawn film are also substantially oriented along a preferred orientation.

In one embodiment, the carbon nanotube drawn film can be drawn out from an array of carbon nanotubes. The carbon nanotube drawn film can be formed by selecting one or more carbon nanotubes having a predetermined width from the array of carbon nanotubes, and pulling the carbon nanotubes at a roughly uniform speed to form carbon nanotube segments that are joined end to end to achieve a uniform carbon nanotube drawn film.

The carbon nanotube segments can be selected by using a tool, such as adhesive tape, pliers, tweezers, or other tools allowing multiple carbon nanotubes to be gripped and pulled simultaneously to contact with the array of carbon nanotubes. Each carbon nanotube segment includes a plurality of carbon nanotubes substantially parallel to each other, and combined by Van der Waals attractive force therebetween. The pulling direction can be substantially perpendicular to the growing direction of the array of carbon nanotubes.

The drawn carbon nanotube film has the smallest resistance at the pulling direction, and the largest resistance at a direction substantially perpendicular to the pulling direction.

The length and width of the carbon nanotube drawn films are not limited, because the carbon nanotube drawn films can be located side by side or stacked with each other. In one embodiment, each carbon nanotube drawn film has a light transmittance greater than 85%, and the number of layers of the carbon nanotube drawn films is not limited, so long as the first conductive layer 12 has proper light transmittance.

In some embodiments, the first conductive layer 12 includes a carbon nanotube composite film. The carbon nanotube composite film includes a carbon nanotube drawn film and polymer materials infiltrating the carbon nanotube drawn film. Spaces can exist between adjacent carbon nanotubes in the carbon nanotube drawn film, and thus the carbon nanotube drawn film includes a number of micropores defined by the adjacent carbon nanotubes therein. The polymer material is filled into the micropores of the carbon nanotube drawn film to form the carbon nanotube composite film. The polymer materials can be distributed uniformly in the carbon nanotube composite film. The carbon nanotube composite film can include one or more carbon nanotube drawn films. The carbon nanotube composite film can have a uniform thickness. A thickness of the carbon nanotube composite film is only limited by the degree of transparency desired. In one embodiment, the thickness of the carbon nanotube composite film can range from about 0.5 nanometers to about 100 microns. The polymer material can be transparent, and not limited to a specific material. The polymer material can be polystyrene, polyethylene, polycarbonate, polymethyl methacrylate (PMMA), polycarbonate (PC), polyethylene terephthalate (PET), benzocyclobutene (BCB), or polyalkenamer. In one embodiment, the polymer material is PMMA.

In some embodiments, the first conductive layer 12 comprises at least one etched or laser-treated carbon nanotube drawn film. The etched or laser-treated carbon nanotube drawn film has an enhanced anisotropic electrical conductivity. For example, a number of cutting lines along the preferred orientation of the carbon nanotubes can be formed in the first carbon nanotube layer along the second direction through laser or etching.

Furthermore, a protection layer 13 can be applied on the first conductive layer 12. The protection layer 13 is used to protect the first conductive layer 12 from damage. Furthermore, the protection layer 13 can also improve the comfort and feel of the touch module 10. The protection layer 13 can also be flexible. A material of the protection layer 13 can be same as the material of the substrate 11.

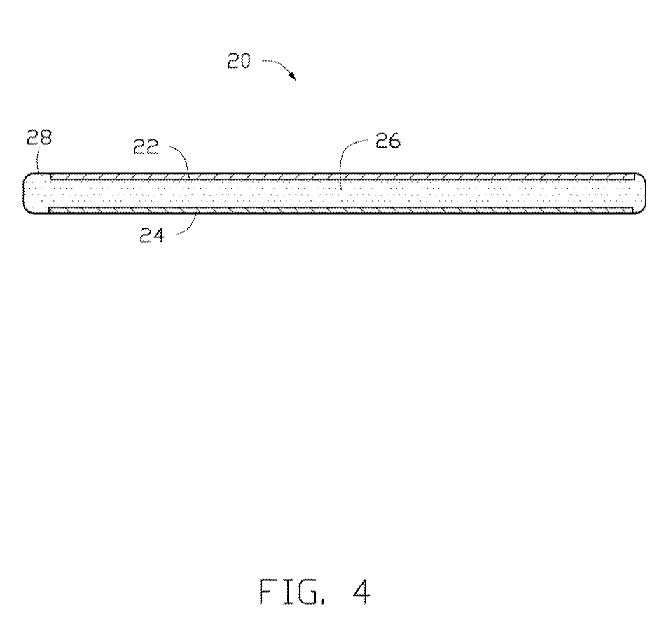

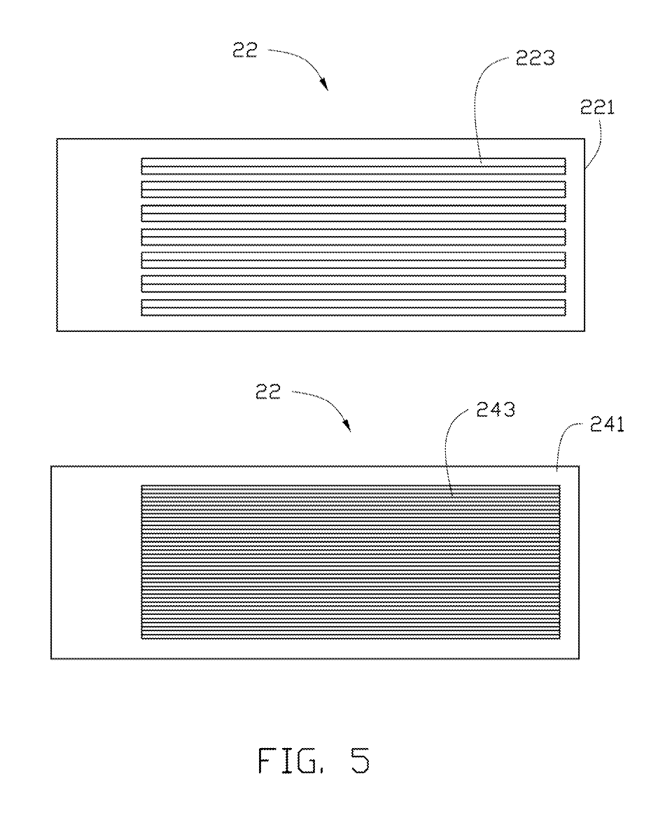

Referring to FIGS. 4-5, the battery module 20 is flexible. The bending angle of the flexible touch module can be equal to or greater than 180°. Furthermore, both touch module 10 and the battery module 20 have the same deformation during deforming the touch module 10, and the battery module 20 is deformed with the deformation of the touch module 10 at the same time. The battery module 20 cannot be divided from the touch module 10 during deformation. The battery module 20 can be bent, fold, twisted, and crimped without damage. The battery module 20 is used to supply power to the touch module 10. The battery module 20 can be a thin film battery. In one embodiment, the battery module 20 can be transparent. The battery module 20 can be a polymer lithium-ion battery, a thin film flexible battery, or a thin film solar battery.

In one embodiment, the battery module 20 is the thin film flexible battery. The battery module 20 comprises a positive electrode 22, a negative electrode 24, an electrolyte 26, and a housing 28. The positive electrode 22 comprises a first carbon nanotube layer 221 and a positive electrode plate 223 stacked together. The first carbon nanotube layer 221 is flexible and comprises at least one carbon nanotube film. The positive electrode plate 223 can also be a flexible structure. In one embodiment, the positive electrode plate 223 comprises a carbon nanotube film and a plurality of positive active material dispersed in the carbon nanotube film.

Each carbon nanotube film can consist of a plurality of carbon nanotubes. The positive active materials are adsorbed on walls of the carbon nanotubes. An amount of the carbon nanotube films in the positive electrode plate 223 is not limited. In one embodiment, the positive electrode plate 223 comprises 3 layers to 6 layers of carbon nanotube films. A large number of the carbon nanotubes in each carbon nanotube film are arranged substantially along the same direction, namely, each carbon nanotube film is an ordered carbon nanotube film. The carbon nanotube film can be the carbon nanotube drawn film. The thickness of the positive electrode plate 223 having 3 layers to 6 layers of carbon nanotube films is in a range from 10 nm to 100 nm. The positive electrode plate 223 has a uniform thickness and a uniform conductivity.

The positive active material can be a commonly used positive active material, such as lithium transition metal oxides. The lithium transition metal oxides can be lithium iron phosphate, lithium cobalt oxides, lithium manganese oxide, LiAl_{1/4}Ni_{3/4}O₂, LiGa_{0.02}Ni_{1.98}O₂, LiNi_{0.5}Mn_{1.5}O₄, LiNi_{0.5}Mn_{0.5}O₂, LiNi_{0.8}Co_{0.2}O₄, LiFe_{0.8}Co_{0.8}O₄, LiNi_{1/3}Mn_{1/3}Co_{1/3}O₂, and LiNi_{0.375}Mn_{0.375}Co_{0.25}O₂. The positive active material can have a shape of particles or grains. A particle or grain size of the positive active material can be in a range from 0.1 nm to 100 μm. The positive active material can be uniformly dispersed in the positive electrode plate 223. The positive active material can be fixed on the carbon nanotube film through the adsorption of the walls of the carbon nanotubes. The positive active material is not filled in all the gaps between the carbon nanotubes in the carbon nanotube films, and does not completely coat the carbon nanotubes. The walls of a majority number of the carbon nanotubes are not coated by the positive active material. The walls, without coating by the positive active material of the adjacent carbon nanotubes, can be directly connected with each other to form a conductive network for improving the electronic conductivity. Because there are the gaps between the carbon nanotubes in the carbon nanotube films, the positive electrode plate 223 is a porous structure, which is good for the penetration of the electrolyte, thus improves the ionic conductivity.

In one embodiment, the positive electrode plate 223 consists of the carbon nanotube film and the positive active material, thus the positive electrode plate 223 is flexible. In one embodiment, the positive electrode plate 223 can be bent, folded, twisted, and crimped.

The first carbon nanotube layer 221 can be in direct contact with the positive electrode plate 223. That is to say, the carbon nanotubes of the first carbon nanotube layer 221 in direct contact with the carbon nanotubes of the positive electrode plate 223. The carbon nanotubes of the positive electrode plate 223 and the first carbon nanotube layer 221 are combined only by van der Waals forces and without an adhesive. The carbon nanotube films of the first carbon nanotube layer 221 and the positive electrode plate 223 have extremely large specific surface area. Once the first carbon nanotube layer 221 and the positive electrode plate 223 are stacked and combined by the van der Waals forces, it will be difficult to separate them from each other. In one embodiment, the positive electrode plate 223 is smaller than the first carbon nanotube layer 221, and located on a portion of the first carbon nanotube layer 221. In one embodiment, the first carbon nanotube layer 221 has a rectangle structure, and the positive electrode plate 223 is located on one end of first carbon nanotube layer 221. The other end of the first carbon nanotube layer 221 can be used to connect to an external circuit.

The negative electrode 24 has the same structure as the positive electrode 22. The negative electrode 24 comprises a second carbon nanotube layer 241 and a negative electrode plate 243. The difference between the negative electrode 24 and the positive electrode 22 is that the negative electrode 24 comprises the negative active material. The second carbon nanotube layer 241 is the anode current collector of the battery module 20. The negative active material is not limited, can be a commonly used negative active material, such as lithium metal, alloy anode material, Sn-based material, silicon-based material, graphite carbon materials, amorphous carbon material and transition metal oxide. The transition metal oxide can be lithium titanate. In one embodiment, the amount of the negative active material in the negative electrode plate 243 is greater than the amount of the positive active material in the positive electrode plate 223. For example, the amount of the negative active materials in the negative electrode plate 243 is 105% of the amount of the positive active material 124 in the positive electrode plate 223.

In the battery module 20, the positive electrode 22 is stacked with the negative electrode 24. The positive electrode plate 223 and the negative electrode plate 243 are spaced and face each other, so that the lithium ion can easily transfer between the positive electrode plate 223 and the negative electrode plate 243. The electrolyte 26 is disposed between the positive electrode plate 223 and the negative electrode plate 243. In one embodiment, the electrolyte 26 in the battery module 20 is liquid electrolyte solution. In some embodiments, the electrolyte 26 is a solid electrolyte membrane or polymer electrolyte membrane, and is sandwiched between the positive electrode plate 223 and the negative electrode plate 243.

The battery module 20 can comprise a soft package structure 28, such as an aluminum-plastic film packaging bag, to enclose the positive electrode 22, the negative electrode 24, and the electrolyte 26. The soft package structure is flexible and can be bent or curved. Furthermore, the battery module 20 with the soft package structure 28 is a film structure and transparent. Furthermore, the battery module 20 can also comprise a plurality of conductive leads (not shown) used to connect to the touch module 10.

The battery module 20 can electrically connect with the touch module 10 via flexible circuit board (FCP) to supply power to the touch module 10. The material of the FCP is a polyimide or polyester film. The FCP can be twisted, curled, and folded. Through the FCP, the flexible touch module 10 can electrically connect with the battery module 20 without affect the electronic device 100 in deformation.

The touch module 10 and the battery module 20 can be tightly stacked together to form an integrated structure, which means that the touch module 10 and the battery module 20 are not separated from each other during process of deformation. Furthermore, the touch module 10 and the battery module 20 can simultaneously deform in the same manner. The touch module 10 can be directly attached to the battery module 20 via an adhesive layer (not shown).

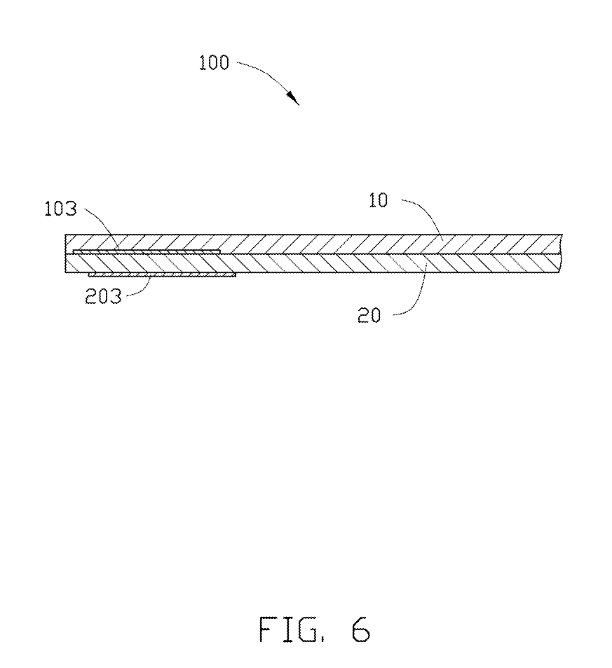

Furthermore, referring to FIG. 6, the battery module 20 can also connect to the touch module 10 via wireless charging. The flexible electronic device 100 can further comprise a wireless sending module 203 and a wireless receiving module 103. Both the wireless sending module 203 and the wireless receiving module 103 are flexible. The wireless sending module 203 can be located on a surface of the battery module 20 away from the touch module 10 and electrically connect to the battery module 20. The wireless sending module 203 comprises a transmit coil and a frequency module oscillator. The transmit coil can send electrical energy. The frequency module oscillator is used to generate LC resonance in the transmit coil, adjust the capacitance value of the LC resonance, and change the resonance frequency of the LC resonance, in order to generate varying electromagnetic field.

The wireless receiving module 103 can be integrated into the touch module 10. In one embodiment, the wireless receiving module 103 can be directly printed on a surface of the substrate 11 away from the first conductive layer 12. The wireless receiving module 103 comprises a receiving coil, and a rectification and communication module. The wireless receiving coil is coupled with the transmit coil to receive the varying electromagnetic field and transfer the varying electromagnetic filed into alternating current. The rectification and communication module are used to transfer the alternating current into direct current supplied to the touch module 10.

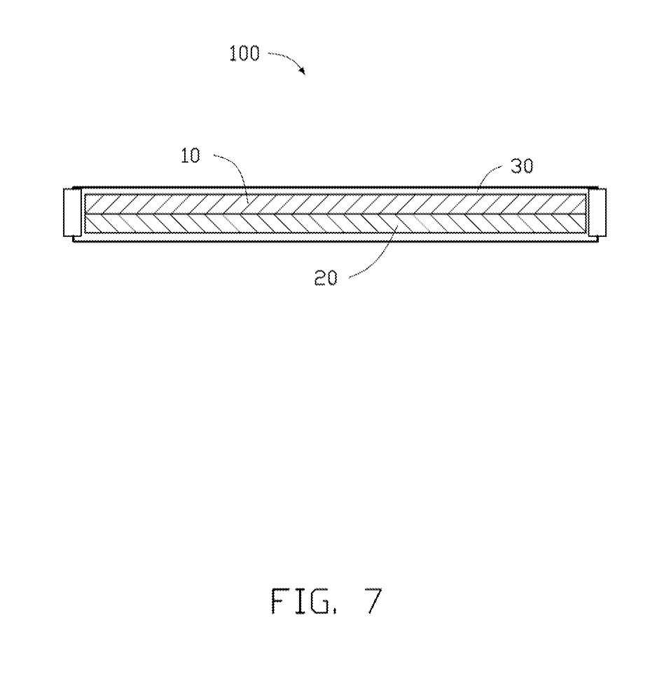

Referring to FIG. 7, the flexible electronic device 100 can further comprise a flexible shell 30 to fix and protect the touch module 10 and the battery module 20. The shell 30 can merely located on edge of the touch module 10 and the battery module 20. In one embodiment, the shell 30 can enclose the touch module 10 and the battery module 20 to form the film structure. The material of the shell 30 can be PET, polyamide, polyethylene, polypropylene, carbon fiber, or carbon nanotube composites.

Furthermore, the flexible electronic device 100 can further comprise a communication module 60 to electrically connect with other device such as TV set or display. The communication module 60 can send control instruction into other device. The communication module 60 can be integrated into the touch module 10 or the battery module 20. The communication module 60 can be a wireless connection module, such as IR module, Bluetooth module, Wi-Fi module, or near field communication module. The communication module 60 can also be a USB module. In one embodiment, the communication module 60 is a Bluetooth module in the shell 30.

In one embodiment, the flexible electronic device 100 comprises an information processing and storage module 70. The information processing and storage module 70 can transfer the touch signals sensed by the touch module 10 into control instruction. The information processing and storage module 70 can be an integrated into the shell 30. Furthermore, the information processing and storage module 70 can also store sensing signals sensed by touch module 10, and transfer the sensing signals into different control instructions. The information processing and storage module 70 can also monitor the capacity and the working condition of the battery module 20, ensuring that the battery module 20 can supply stable driving and sensing voltage to the touch module 10.

The flexible electronic device has following advantages. Both the touch module and the battery module are flexible, and the bending angle of both the touch module and the battery can be greater than 180°. Thus the flexible electronic can be bent, folded, and wound. Therefore it is convenient to attach the flexible electronic device to any surface. Furthermore, the flexible electronic device is transparent, thus the flexible electronic device can be attached to the traditional display to form a touch screen. The battery module has integrated into the flexible electronic device, thus the flexible electronic device is capable of working and communicating with other electronic devices without additional power supply. In additional, the flexible electronic device can communicate with other electronic devices, and send control instruction to other electronic devices while the touch module is touched. The flexible electronic device can be attached to the wall, the desk, or furniture and control other electronic device such as TV set.

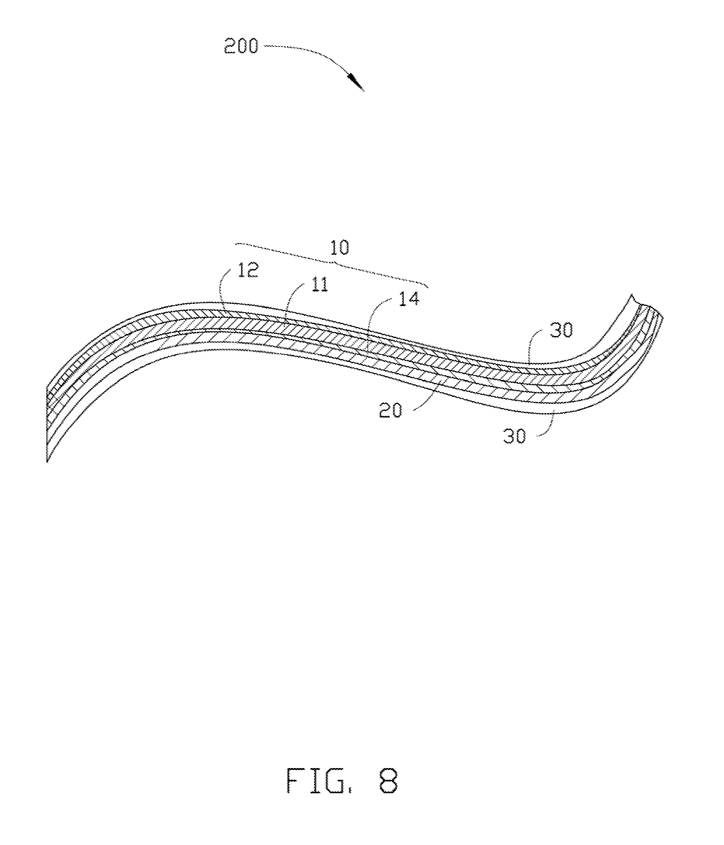

Referring to FIG. 8, one embodiment of a flexible electronic device 200 comprises a touch module 10 and a battery module 20 stacked together. The touch module 10 comprises a substrate 11, a first conductive layer 12, and a second conductive layer 14. The first conductive layer 12 and the second conductive layer 14 are located on two opposite surface of the substrate 11. Both the touch module 10 and the battery module 20 are flexible.

The structure of the flexible electronic device 200 is similar to the flexible electronic device 100, except that the touch module 10 comprises the first conductive layer 12 and the second conductive layer 14. The first conductive layer 12 and the second conductive layer 14 are worked together to sense touch signal.

The substrate 11 can comprise a first surface and a second surface, opposite to the first surface. The first conductive layer 12 can be attached to the first surface, and the second conductive layer 14 can be attached to the second surface. The second conductive layer 14 can be a unidirectional conductive layer comprising a plurality of conductive belts aligned along the same direction. The second conductive layer 14 can also be an anisotropic impedance layer. In one embodiment, the plurality of conductive belts are aligned perpendicular with the relatively low impedance direction D of the first conductive layer 12. In one embodiment, the second conductive layer 14 comprises a plurality of indium tin oxide belts.

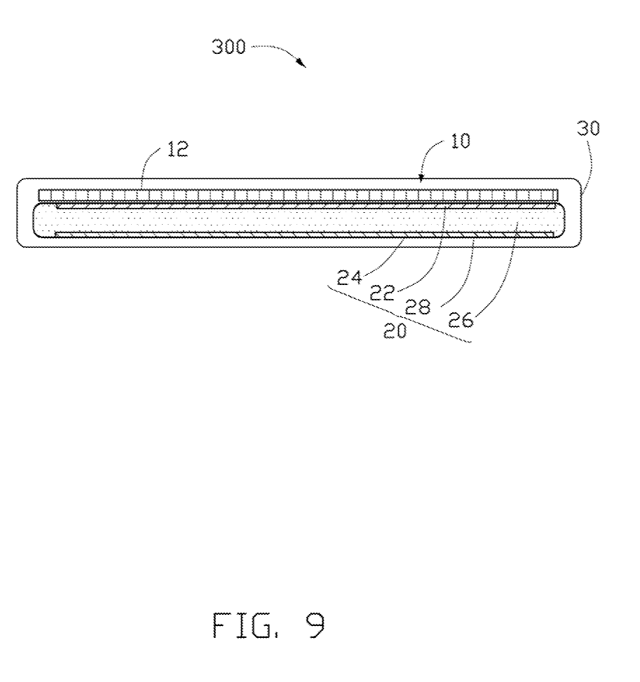

Referring to FIG. 9, one embodiment of a flexible electronic device 300 comprises a touch module 10 and a battery module 20 overlapped with each other. The structure of the flexible electronic device 300 is similar to the flexible electronic device 100, except that the substrate 11 is omitted and the first conductive layer 12 is directly attached to a surface of housing 28 of the battery module 20.

The first conductive layer 12 can be supported by the housing 28 to form the touch module 10. Thus the substrate 11 in the flexible electronic device 100 can be omitted, the thickness of the flexible electronic device 300 can be reduced, and the flexibility of the flexible electronic device 300 can be improved.

Furthermore, a protective layer 30 can be applied on the first conductive layer 12 to protect the first conductive layer 12 from damage. In one embodiment, the protective layer 30 covers the first conductive layer 12.

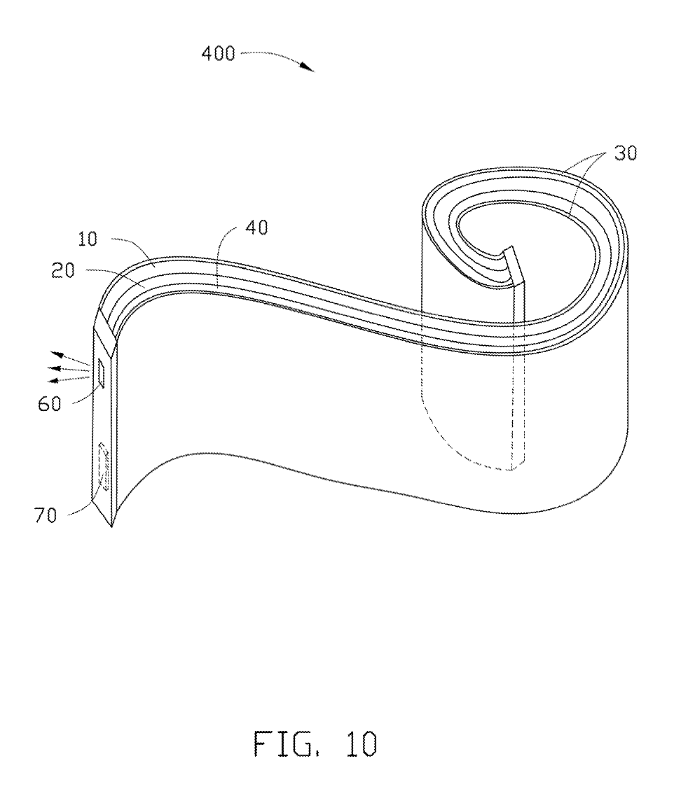

Referring to FIG. 10, one embodiment of a flexible electronic device 400 comprises a touch module 10, a battery module 20, and a display module 40 stacked together. The battery module 20 is sandwiched between the touch module 10 and the display module 40.

The structure of flexible electronic device 400 is similar to the flexible electronic device 200, except that the flexible electronic device 400 further comprises the display module 40.

The flexible electronic device 400 can display action menu and appropriate information based on the user's instructions. A thickness of the display module 40 can range from 10 micrometers to 0.5 micrometers. The display module 40 can be an electroluminescence display, an electrophoretic display, an electrochromic displays, a liquid crystal display, an active matrix liquid crystal display, a plasma display panel, an organic light emitting diode display, or electronic ink display. The display module 40 can connect with the touch module 10 via FPC or wireless to display the information. Furthermore, the display module 40 can also connect with the battery module 20 via FPC or wireless.

Because the battery module 20 is transparent, thus the information and image on the display module 40 can be transmitted through the battery module 20 and the touch module 10. In one embodiment, the touch module 10, the battery module 20, and the display module 40 are integrated into an integrated structure, and cannot be separated during bending, folding, and other deformation.

The flexible electronic device 400 comprises the display module 40 and forms a touch screen. The flexible electronic device 400 can be attached to the switches, keyboards, or remote controller and function as an interactive input/output device. Other electronic device such as TV set can be controlled by touching the flexible electronic device 400. Furthermore, the flexible electronic device 400 can be used in wearable devices such as clothes.

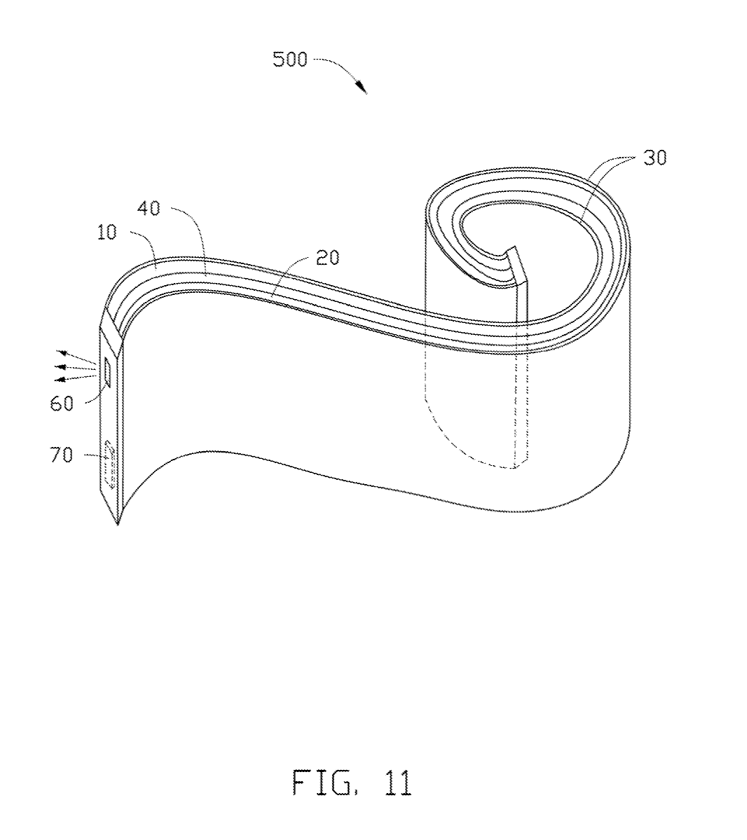

Referring to FIG. 11, one embodiment of a flexible electronic device 500 comprises a touch module 10, a display module 40, and a battery module 20 stacked together. The display module 40 is sandwiched between the touch module 10 and the battery module 20. The flexible electronic device 500 is similar to the flexible electronic device 400, except that the display module 40 is sandwiched between the touch module 10 and the battery module 20.

The display module 40 and the touch module 10 are stacked on the battery module 20. In one embodiment, both the display module 40 and the touch module 10 are communicated with the battery module 20 via wireless.

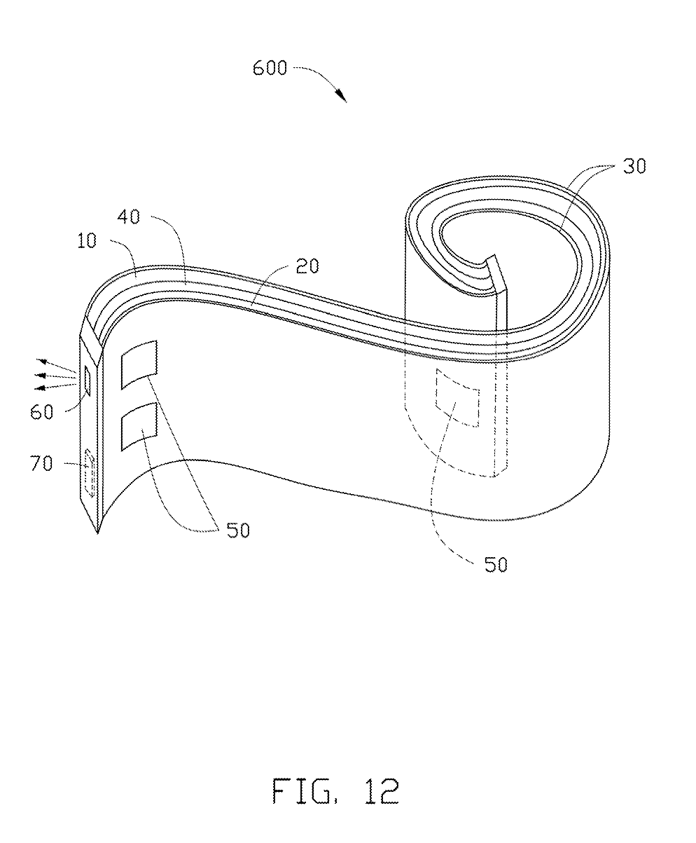

Referring to FIG. 12, one embodiment of a flexible electronic device 600 comprises a touch module 10, a display module 40, a battery module 20, and a plurality of sensors 50. The touch module 10, the display module 40, and the battery module 20 are stacked together. The plurality of sensors 50 are located in the touch module 10, the display module 40, and the battery module 20. The plurality of sensors 50 are used to sense the deformation of the flexible electronic device 600 and the circumstance variety, and transfer them into electronic signals which are dealt with by information processing and storage module 70.

The flexible electronic device 600 is similar to the flexible electronic device 400, except that the flexible electronic device 600 further comprises a plurality of sensors 50. The plurality of sensors 50 can be integrated into the touch module 10, the display module 40, or the battery module 20. In one embodiment, the plurality of sensors 50 are integrated into the edges of the substrate 11 to avoid affecting the touch module 10. In another embodiment, the plurality of sensors 50 are integrated into the housing 28 in the battery module 20 to sense the deformation of flexible electronic device 600.

Each of the plurality of sensors 50 can be a proximity sensor, pressure sensor, touch sensor, optical sensors, or gravity sensor. The plurality of sensors 50 can sense different deformations and convert them into different control commands. Thus the display module 40 can display different interfaces and functions according to the control commands. The plurality of sensors can also sense gravity, ambient brightness, pressure, or object approaches.

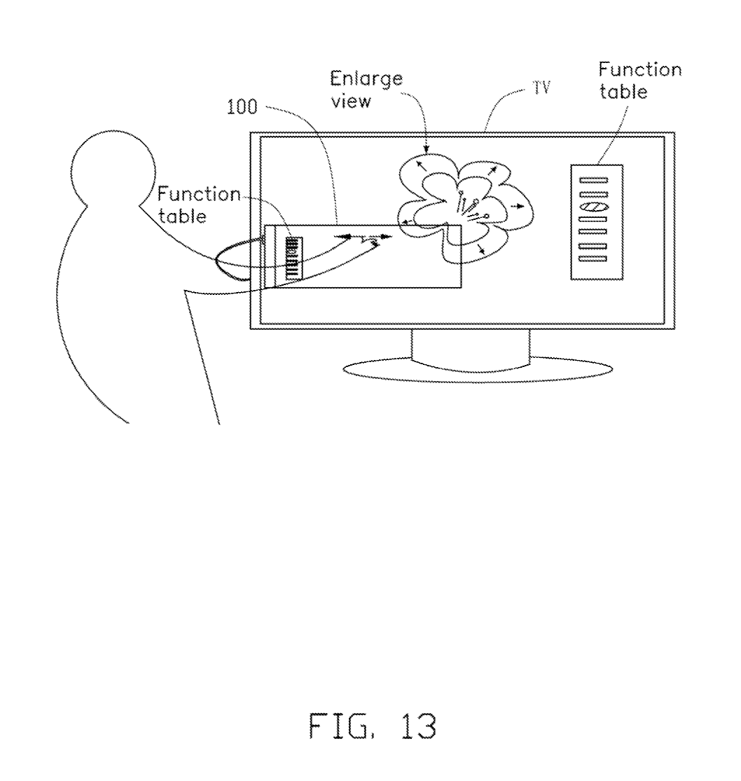

The flexible electronic device is flexible and transparent, and can be applied on to different surfaces. Referring to FIG. 13, one embodiment of applying the flexible electronic device on a smart TV via USB. The flexible electronic device senses the touch and transfer the touch into control commands. The control commands will be transferred into the smart TV to control the smart TV. In one embodiment, enlarging or diminishing the images, switching channels, or adjusting the sound, can be achieved by sliding fingers on the flexible electronic device. Furthermore, by touching the function table on the flexible electronic device, switching channels, adjusting the sounds, or adjusting the color can also be achieve. Thus any remote controller can be omitted.

It is to be understood that the described embodiments are intended to illustrate rather than limit the disclosure. Any elements described in accordance with any embodiments is understood that they can be used in addition or substituted in other embodiments. Embodiments can also be used together. Variations may be made to the embodiments without departing from the spirit of the disclosure. The disclosure illustrates but does not restrict the scope of the disclosure.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A flexible electronic device, the flexible electronic device comprises:
a shell;
a touch module located in the shell capable of inputting signals and converting the input signals into electronic signals;
a battery module stacked on the touch module, wherein the battery module is capable of supplying power to the touch module, and all of the shell, the touch module, and the battery module are flexible, and the battery module is capable of deforming with a deformation of the touch module;
an information processing and storage module, wherein the information processing and storage module is capable of converting the electronic signals into control commands; and
a communication module electrically connected to the information processing and storage module.

2. The flexible electronic device of claim 1, wherein the touch module comprises a substrate and a first conductive layer located on the substrate, and both the substrate and the first conductive layer are flexible.

3. The flexible electronic device of claim 2, wherein all of the shell, the touch module, and the battery module are capable of deforming at the same time.

4. The flexible electronic device of claim 3, wherein the touch module and the battery module have the same deformation.

5. The flexible electronic device of claim 4, wherein the battery module is transparent and capable of being bent, fold, twisted, and crimped without damage.

6. The flexible electronic device of claim 5, further comprising a second conductive layer, wherein the first conductive layer and the second conductive layer are located on two opposite surfaces of the substrate.

7. The flexible electronic device of claim 2, wherein a material of the substrate is selected form the group consisting of polyethylene terephthalate, cycloolefincopolymer, polycarbonate polystyrene, polyethylene, polymethyl methacrylate, and polyimide.

8. The flexible electronic device of claim 1, wherein the touch module and the battery module are combined together to form an integrated structure.

9. The flexible electronic device of claim 1, wherein the battery module comprises a positive electrode, a negative electrode, and an electrolyte; and the positive electrode, the negative electrode, and the electrolyte are enclosed by a housing.

10. The flexible electronic device of claim 9, wherein the positive electrode comprises a first carbon nanotube layer and a flexible positive electrode plate, and the flexible positive electrode plate comprises a plurality of positive active material dispersed in a first carbon nanotube film.

11. The flexible electronic device of claim 9, wherein the negative electrode comprises a second carbon nanotube layer and a flexible negative electrode plate, and the flexible negative electrode plate comprises a plurality of negative active material dispersed in a second carbon nanotube film.

12. The flexible electronic device of claim 1, further comprising a wireless sending module and a wireless receiving module; wherein the wireless sending module is located on the battery module and supply electrical energy to the touch module, and the wireless receiving module is located on the touch module and receive the electrical energy.

13. The flexible electronic device of claim 1, wherein the communication module is selected from the group consisting of IR module, Bluetooth module, Wi-Fi module, and near field communication module.

14. A flexible electronic device, the flexible electronic device comprises:
a battery module, wherein the battery module is flexible and comprises a positive electrode, a negative electrode, and an electrolyte enclosed in a housing;
a carbon nanotube film attached on an outer surface of the housing, wherein the carbon nanotube film and the housing form a touch module.

15. The flexible electronic device of claim 14, wherein the carbon nanotube film is flexible and comprises a plurality of carbon nanotubes substantially aligned along the same direction.

16. A flexible electronic device, wherein the flexible electronic device comprises a touch module, a display module, and a transparent battery module stacked together, all of the touch module, the display module, and the transparent battery module are flexible, the transparent battery module is configured to supply power for the touch module and the display module, and the display module is configured to receive signals from the touch module.

17. The flexible electronic device of claim 16, wherein the transparent battery module is sandwiched between the touch module and the display module.

18. The flexible electronic device of claim 16, wherein the display module is sandwiched between the touch module and the transparent battery module.

19. The flexible electronic device of claim 16, wherein the touch module, the display module, and the transparent battery module are combined together to form an integrated structure.

20. The flexible electronic device of claim 16, further comprises a plurality of sensors, wherein the plurality of sensors are integrated into the touch module, the display module, and the transparent battery module and configured to sense deformation and circumstance variety.
